(19) United States
(12) Patent Application Publication
(10) Pub. No.: US 2017/0348680 A1
(43) Pub. Date: Dec. 7, 2017

(54) TRIALKYLPHOSPHONIUM IONIC LIQUIDS, METHODS OF MAKING, AND ALKYLATION PROCESSES USING TRIALKYLPHOSPHONIUM IONIC LIQUIDS

(71) Applicant: Cytec Industries Inc., Woodland Park, NJ (US)

(72) Inventors: Donato Nucciarone, Stoney Creek, CA (US); Avram Michael Buchbinder, Chicago, IL (US); Susie C. Martins, Carol Stream, IL (US); Douglas Andrew Nafis, Mt. Prospect, IL (US)

(73) Assignee: Cytec Industries Inc., Woodland Park, NJ (US)

(21) Appl. No.: 15/615,970

(22) Filed: Jun. 7, 2017

Related U.S. Application Data
(60) Provisional application No. 62/346,831, filed on Jun. 7, 2016.
(60) Provisional application No. 62/346,813, filed on Jun. 7, 2016.

(51) Int. Cl. B01J 31/02

(52) U.S. Cl. CPC B01J 31/0288; B01J 31/0231; B01J 2231/32

(57) ABSTRACT

A trialkylphosphonium haloaluminate compound having a formula:

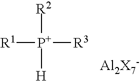

where R¹, R², and R³ are the same or different and each is independently selected from C₁ to C₈ hydrocarbyl; and X is selected from F, Cl, Br, I, or combinations thereof is described. An ionic liquid catalyst composition incorporating the trialkylphosphonium haloaluminate compound, methods of making the trialkylphosphonium haloaluminate compound, and alkylation processes incorporating the trialkylphosphonium haloaluminate compound are also described.

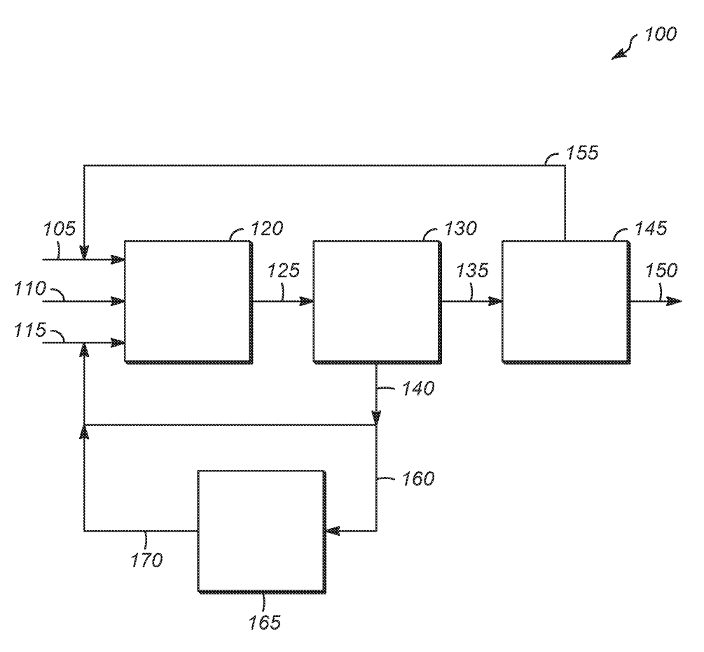

### CROSS-REFERENCE TO RELATED APPLICATIONS

This application claims the priority benefit of U.S. Provisional Application No. 62/346,831 filed on Jun. 7, 2016, and of U.S. Provisional Application No. 62/346,813 filed on Jun. 7, 2016. Each of these applications is incorporated herein by reference in its entirety.

### FIELD OF THE INVENTION

The invention relates to phosphonium-halide salts. More specifically, the invention relates to phosphonium-haloaluminate ionic liquids, and their use as catalysts in processes for the alkylation of paraffins with olefins.

### BACKGROUND OF THE INVENTION

Alkylation is typically used to combine light olefins, for example mixtures of alkenes such as propylene and butylene, with isobutane to produce a relatively high-octane branched-chain paraffinic hydrocarbon fuel, including isoheptane and isooctane. Similarly, an alkylation reaction can be performed using an aromatic compound such as benzene in place of the isobutane. When using benzene, the product resulting from the alkylation reaction is an alkylbenzene (e.g. ethylbenzene, cumene, dodecylbenzene, etc.).

The alkylation of paraffins with olefins for the production of alkylate for gasoline can use a variety of catalysts. The choice of catalyst depends on the end product a producer desires. Typical alkylation catalysts include concentrated sulfuric acid or hydrofluoric acid. However, sulfuric acid and hydrofluoric acid are hazardous and corrosive, and their use in industrial processes requires a variety of environmental controls.

Solid catalysts are also used for alkylation. Solid catalysts are more readily deactivated by the adsorption of coke precursors on the catalyst surface.

Acidic ionic liquids can be used as an alternative to the commonly used strong acid catalysts in alkylation processes. Ionic liquids are salts comprised of cations and anions which typically melt below about 100° C. Ionic liquids are essentially salts in a liquid state, and are described in U.S. Pat. Nos. 4,764,440, 5,104,840, and 5,824,832. The properties vary extensively for different ionic liquids, and the use of ionic liquids depends on the properties of a given ionic liquid. Depending on the organic cation of the ionic liquid and the anion, the ionic liquid can have very different properties.

Ionic liquids provide advantages over other catalysts, including being less corrosive than catalysts like HF, and being non-volatile.

Although ionic liquid catalysts can be very active, alkylation reactions need to be run at low temperatures, typically between −10° C. to 30° C., to maximize the alkylate quality. This requires cooling the reactor and reactor feeds, which adds substantial cost to an alkylation process utilizing ionic liquids in the form of additional equipment and energy. The most common ionic liquid catalyst precursors for alkylation include imidazolium, or pyridinium-based cations coupled with the chloroaluminate anion (Al₂Cl₇⁻).

Alkylation processes using quaternary phosphonium haloaluminate ionic liquids are known, for example, U.S. Pat. Nos. 9,156,028, and 9,156,747, and US Publication No. 2014/0213435. These patents and application cover tetra-alkyl phosphonium ionic liquid catalysts of the formula:

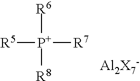

In some embodiments, R⁵-R⁸ comprise alkyl groups having from 4 to 12 carbon atoms, R⁵-R⁷ are the same alkyl group, and R⁸ is different from R⁵-R⁷ and contains more carbon atoms, and X is a halogen. In other embodiments, R⁵-R⁷ are the same and comprise alkyl groups having from 1 to 8 carbon atoms, and R⁸ is different from R⁵-R⁷ and comprises an alkyl group having from 4 to 12 carbon atoms, and X is a halogen. The quaternary phosphonium haloaluminate ionic liquids were successfully used to produce high octane products at temperatures above or near ambient. However, these ionic liquids have a viscosity in the range of 50 to 115 cSt at 25° C. This may be higher than desirable in some applications.

Therefore, there is a need for ionic liquids having a lower viscosity than quaternary phosphonium haloaluminate ionic liquids, which produce high octane alkylate, and which do not require operation under more extreme conditions such as refrigeration.

### BRIEF DESCRIPTION OF THE DRAWING

The FIGURE is an illustration of one embodiment of an alkylation process of the present invention.

### SUMMARY OF THE INVENTION

This summary of the invention does not list all necessary characteristics and, therefore, subcombinations of these characteristics may also constitute an invention.

Accordingly, one aspect of the invention is a trialkylphosphonium haloaluminate compound. In one embodiment, the trialkylphosphonium haloaluminate compound has the formula:

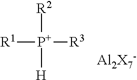

where R¹, R², and R³ are the same or different and each is independently selected from C₁ to C₈ hydrocarbyl; and X is selected from F, Cl, Br, I, or combinations thereof; with the proviso that when X is Cl, R¹, R², and R³ are not all methyl.

Another aspect of the invention is an ionic liquid catalyst composition. In one embodiment, the ionic liquid catalyst composition comprises one or more trialkylphosphonium haloaluminate compounds as described above.

Another aspect of the invention is a process of making the trialkylphosphonium haloaluminate compound. In one embodiment, the process includes reacting a trialkylphosphonium halide having a general formula:

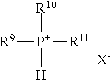

where R⁹ R¹⁰, and R¹¹ are the same or different and each is independently selected from C₁ to C₈ hydrocarbyl; and X is selected from F, Cl, Br, or I; with at least one of AlCl₃, AlBr₃ or AlI₃ to form the trialkylphosphonium haloaluminate ionic liquid compound.

Another aspect of the invention is an alkylation process. In one embodiment, the alkylation process includes contacting an isoparaffin feed having from 4 to 10 carbon atoms and an olefin feed having from 2 to 10 carbon atoms in the presence of a trialkylphosphonium ionic liquid catalyst composition in an alkylation zone under alkylation conditions to generate an alkylate. The trialkylphosphonium ionic liquid catalyst composition comprises one or more trialkylphosphonium haloaluminate compounds having a formula:

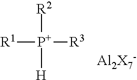

where R¹, R², and R³ are the same or different and each is independently selected from C₁ to C₈ hydrocarbyl; and X is selected from F, Cl, Br, I, or combinations thereof.

### DETAILED DESCRIPTION OF THE INVENTION

The present invention relates to trialkylphosphonium haloaluminate compounds, ionic liquid catalysts compositions comprising trialkylphosphonium haloaluminate compositions, processes of making the trialkylphosphonium haloaluminate compounds, and alkylation processes using the ionic liquid catalyst compositions.

The terms “comprised of,” “comprising,” or “comprises” as used herein includes embodiments “consisting essentially of” or “consisting of” the listed elements.

The trialkylphosphonium haloaluminate compounds have the formula:

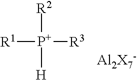

where R¹, R², and R³ are the same or different and each is independently selected from C₁ to C₈ hydrocarbyl; and X is selected from F, Cl, Br, I, or combinations thereof.

In any or all embodiments, R¹, R², and R³ are selected from C₁ to C₆ hydrocarbyl, or C₃ to C₆ hydrocarbyl, or C₃ to C₅ hydrocarbyl. In additional or alternate embodiments, R¹, R², and R³ have the same number of carbon atoms. In the same or alternate embodiments, R¹, R², and R³ are identical. In any or all embodiments, R¹, R², and R³ can be selected from the group consisting of methyl, ethyl, propyl, butyl, pentyl, and hexyl (including all isomers, e.g., butyl may be n-butyl, sec-butyl, isobutyl, and the like).

In any or all embodiments, when X is Cl, R¹, R², and R³ are not all methyl. In the same or alternate embodiments, when X is Cl, only one of R¹, R², and R³ is methyl. In additional or alternate embodiments, when X is Cl, R¹, R², and R³ are not methyl.

The term “hydrocarbyl” as used herein is used in its ordinary sense and is meant to encompass aliphatic (linear or branched), alicyclic, and aromatic groups having an all-carbon backbone and consisting of carbon and hydrogen atoms, typically from 1 to 36 carbon atoms in length. Examples of hydrocarbyl groups include alkyl, cycloalkyl, cycloalkenyl, carbocyclic aryl, alkenyl, alkynyl, alkylcycloalkyl, cycloalkylalkyl, cycloalkenylalkyl, and carbocyclic aralkyl, alkaryl, aralkenyl and aralkynyl groups.

Those skilled in the art will appreciate that while preferred embodiments are discussed in more detail below, multiple embodiments of the phosphonium haloaluminate compounds as defined above are contemplated as being within the scope of the present invention. Thus, it should be noted that any feature described with respect to one aspect or one embodiment of the invention is interchangeable with another aspect or embodiment of the invention unless otherwise stated.

Furthermore, for purposes of describing the present invention, where an element, component, or feature is said to be included in and/or selected from a list of recited elements, components, or features, those skilled in the art will appreciate that in the related embodiments of the invention described herein, the element, component, or feature can also be any one of the individual recited elements, components, or features, or can also be selected from a group consisting of any two or more of the explicitly listed elements, components, or features. Additionally, any element, component, or feature recited in such a list may also be omitted from such list.

Those skilled in the art will further understand that any recitation herein of a numerical range by endpoints includes all numbers subsumed within the recited range (including fractions), whether explicitly recited or not, as well as the endpoints of the range and equivalents. Disclosure of a narrower range or more specific group in addition to a broader range or larger group is not a disclaimer of the broader range or larger group.

In any or all embodiments, the trialkylphosphonium haloaluminate compound can be tri-n-butylphosphonium Al₂Cl₇⁻. In any or all embodiments, the trialkylphosphonium haloaluminate compound can be tri-isobutylphosphonium Al₂Cl₇⁻. In additional or alternate embodiments, the trialkylphosphonium haloaluminate compound is di-n-butyl-sec-butylphosphonium Al₂Cl₇⁻.

In any or all embodiments of the invention, the trialkylphosphonium haloaluminate compound has the formula

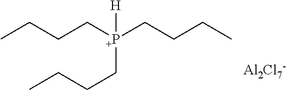

Another aspect of the invention is an ionic liquid catalyst composition. The ionic liquid catalyst composition can comprise one or more trialkylphosphonium haloaluminate compounds, as described above.

In any or all embodiments, the initial kinematic viscosity of the ionic liquid catalyst composition is less than about 70 cSt at 25° C., or less than about 65 cSt, or less than about 60 cSt, or less than about 55 cSt, or less than about 50 cSt, or less than about 45 cSt, or less than about 40 cSt. In additional or alternate embodiments, the initial kinematic viscosity of the ionic liquid catalyst is less than about 45 cSt at 38° C., or less than about 40 cSt, or less than about 35 cSt, or less than about 30 cSt, or less than about 25 cSt. In the same or other embodiments, the initial kinematic viscosity of the ionic liquid catalyst is less than about 33 cSt at 50° C., or less than about 30 cSt, or less than about 25 cSt, or less than about 20 cSt, or less than about 18 cSt.

The relative density of the ionic liquid is typically in the range of about 1.10 to about 1.35 g/cm³ at 25° C. using ASTM method D4052 for chloroaluminates, or about 1.20 to about 1.25 g/cm³.

In any or all embodiments, the molar ratio of aluminum to phosphorous in the ionic liquid catalyst composition is in the range of 1.8 to 2.2.

The ionic liquid catalyst composition can include other ionic liquids. In any or all embodiments, the ionic liquid catalyst composition can include a quaternary phosphonium haloaluminate compound having a formula:

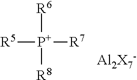

where R⁵-R⁷ are the same or different and each is independently selected from a C₁ to C₈ hydrocarbyl; R⁸ is different from R⁵-R⁷ and is selected from a C₁ to C₁₅ hydrocarbyl; and X is selected from F, Cl, Br, I, or combinations thereof. In any or all embodiments, each of R⁵-R⁷ is independently chosen from a C₃-C₆ alkyl. In any or all embodiments, R⁵-R⁷ are the same. In any or all embodiments, R⁸ is a C₄-C₁₂ hydrocarbyl. In additional or alternate embodiments, R⁸ is a C₄-C₈ alkyl.

The concentration of the one or more trialkylphosphonium haloaluminate compounds is about 5 mol % to about 100 mol % of the total concentration of the ionic liquid compounds, or about 10 mol % to about 100 mol %, about 15 mol % to about 100 mol %, or about 20 mol % to about 100 mol %, or about 25 mol % to about 100 mol %, or about 30 mol % to about 100 mol %, or about 35 mol % to about 100 mol %, or about 40 mol % to about 100 mol %, or about 45 mol % to about 100 mol %, or about 50 mol % to about 100 mol %, or about 55 mol % to about 100 mol %, or about 60 mol % to about 100 mol %, or about 65 mol % to about 100 mol %, or about 70 mol % to about 100 mol %, or about 75 mol % to about 100 mol %, or about 80 mol % to about 100 mol %, or about 85 mol % to about 100 mol %, or about 90 mol % to about 100 mol %. The co-catalyst is not included in the mol % of the ionic liquid compounds. In certain embodiments, there may be less than about 1 mol % impurities.

In embodiments containing one or more quaternary phosphonium haloaluminate compounds, the concentration of the one or more trialkylphosphonium haloaluminate compounds is about 5 mol % to about 98 mol % of the total concentration of the ionic liquid compounds, or about 10 mol % to about 98 mol %, about 15 mol % to about 98 mol %, or about 20 mol % to about 98 mol %, or about 25 mol % to about 98 mol %, or about 30 mol % to about 98 mol %, or about 35 mol % to about 98 mol %, or about 40 mol % to about 98 mol %, or about 45 mol % to about 98 mol %, or about 50 mol % to about 98 mol %, or about 55 mol % to about 98 mol %, or about 60 mol % to about 98 mol %, or about 65 mol % to about 98 mol %, or about 70 mol % to about 98 mol %, or about 75 mol % to about 98 mol %, or about 80 mol % to about 98 mol %, or about 85 mol % to about 98 mol %, or about 90 mol % to about 98 mol %. The concentration of the one or more tetraalkylphosphonium haloaluminate compounds is about 2 mol % to about 95 mol % of the total concentration of the ionic liquid compounds, or about 2 mol % to about 90 mol %, or about 2 mol % to about 85 mol %, or about 2 mol % to about 80 mol %, or about 2 mol % to about 75 mol %, or about 2 mol % to about 70 mol %, or about 2 mol % to about 65 mol %, or about 2 mol % to about 60 mol %, or about 2 mol % to about 55 mol %, or about 2 mol % to about 50 mol %, or about 2 mol % to about 45 mol %, or about 2 mol % to about 40 mol %, or about 2 mol % to about 35 mol %, or about 2 mol % to about 30 mol %, or about 2 mol % to about 25 mol %, or about 2 mol % to about 20 mol %, or about 2 mol % to about 15 mol %, or about 2 mol % to about 10 mol %. The co-catalyst is not included in the mol % of the ionic liquid compounds.

In any or all embodiments, the trialkylphosphonium haloaluminate compound is present at a concentration from about 51 mol % to about 98 mol % of the total concentration of the ionic liquid catalyst composition.

In any or all embodiments, the ionic liquid catalyst composition can include a co-catalyst (or catalyst promoter). The co-catalyst is present in an amount of about 0.05 mol to about 1 mol of co-catalyst per mol of haloaluminate ionic liquid, or about 0.05 mol to about 0.7 mol, or about 0.06 mol to about 0.5 mol, or about 0.15 mol to about 0.7 mol, or about 0.15 mol to about 0.5 mol. The co-catalyst may be a Brønsted acid and/or a Brønsted acid precursor. Suitable Brønsted acid include, but are not limited to, HCl, HBr, HI, and mixtures thereof. Suitable Brønsted acid precursors include, but are not limited to, 2-chlorobutane, 2-chloro-2-methylpropane, 1-chloro-2-methylpropane, 1-chlorobutane, 2-chloropropane, 1-chloropropane and other chloroalkanes, preferably secondary or tertiary chloroalkanes, or combinations thereof.

The trialkylphosphonium haloaluminate ionic liquid compound can be made by reacting a trialkylphosphonium halide having a general formula:

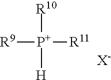

with at least one of AlCl₃, AlBr₃ or AlI₃ to form the trialkylphosphonium haloaluminate ionic liquid compound. R⁹, R¹⁰, and R¹¹ are the same or different and each is independently selected from C₁ to C₈ hydrocarbyl; and X is selected from F, Cl, Br, or I.

In any or all embodiments, R⁹, R¹⁰, and R¹¹ are selected from C₁ to C₆ hydrocarbyl, or C₃ to C₆ hydrocarbyl, or C₃ to C₅ hydrocarbyl, or C₄ hydrocarbyl. In the same or alternate embodiments, R⁹, R¹⁰, and R¹¹ have the same number of carbon atoms. In additional or same embodiments, R⁹, R¹⁰, and R¹¹ can be identical. In any or all embodiments, R⁹, R¹⁰, and R¹¹ are selected from the group consisting of methyl, ethyl, propyl, butyl, pentyl, and hexyl (including all isomers, e.g., butyl may be n-butyl, sec-butyl, isobutyl, and the like).

In any or all embodiments, the trialkylphosphonium halide comprises trimethyl phosphonium halide, triethyl phosphonium halide, tripropyl phosphonium halide, tri n-butyl phosphonium halide, tri-isobutyl phosphonium halide, di-n-butyl-sec-butylphosphonium halide, tripentyl phosphonium halide, trihexylphosphonium halide, or combinations thereof.

The reaction can take place at a temperature in the range of about 20° C. to about 170° C. and under an inert environment.

The reaction can utilize about 1.8 to about 2.2 molar equivalents of AlCl₃, AlBr₃ or AlI₃.

The ionic liquid catalyst composition can be used in alkylation reactions. It has been found that alkylation reactions using trialkylphosphonium haloaluminate ionic liquids give high octane products when carried out at temperatures above or near ambient temperature. This provides for an operation that can substantially save on cost by removing refrigeration equipment from the process. The present invention provides a process for the alkylation of paraffins using trialkylphosphonium haloaluminate ionic liquids.

The acidity of the ionic liquid catalyst composition needs to be controlled to provide for suitable alkylation conditions. Brønsted acids and Brønsted acid precursors may be employed as a co-catalyst to enhance the activity of the catalyst composition by boosting the overall acidity of the trialkylphosphonium ionic liquid catalyst composition. Suitable Brønsted acids and Brønsted acid precursors are discussed above.

Typical alkylation reaction conditions include a temperature in the range of about −20° C. to the decomposition temperature of the ionic liquid, or about −20° C. to about 100° C., or about −20° C. to about 80° C., or about 0° C. to about 80° C., or about 20° C. to about 80° C., or about 20° C. to about 70° C., or about 20° C. to about 50° C. Ionic liquids can also solidify at moderately high temperatures, and therefore it is preferred to have an ionic liquid that maintains its liquid state through a reasonable temperature span. In some embodiments, cooling may be needed. If cooling is needed, it can be provided using any known methods.

The pressure is typically in the range of atmospheric (0.1 MPa(g)) to about 8.0 MPa(g), or about 0.3 MPa(g) to about 2.5 MPa(g). The pressure is preferably sufficient to keep the reactants in the liquid phase.

The residence time of the reactants in the reaction zone is in the range of a few seconds to hours, or about 0.5 min to about 60 min, or about 1 min to about 60 min, or about 3 min to about 60 min.

The ionic liquid catalyst composition volume in the reactor may be from about 1 vol % to about 75 vol % of the total volume of material in the reactor (ionic liquid catalyst composition and hydrocarbons), or about 1 vol % to about 70 vol %, or about 1 vol % to about 65 vol %, or about 1 vol % to about 60 vol %, or about 1 vol % to about 55 vol %, or about 1 vol % to about 50 vol %, or about 1 vol % to about 45 vol %, or about 1 vol % to about 40 vol %, or about 1 vol % to about 35 vol %, or about 1 vol % to about 30 vol %, or about 1 vol % to about 25 vol %, or about 1 vol % to about 20 vol %, or about 1 vol % to about 15 vol %, or about 1 vol % to about 10 vol %, or about 1 vol % to about 5 vol %.

Due to the low solubility of hydrocarbons in ionic liquids, olefins-isoparaffins alkylation, like most reactions in ionic liquids, is generally biphasic and takes place at the interface in the liquid state. The catalytic alkylation reaction is generally carried out in a liquid hydrocarbon phase, in a batch system, a semi-batch system or a continuous system using one reaction stage as is usual for aliphatic alkylation. The isoparaffin and olefin can be introduced separately or as a mixture. The molar ratio between the isoparaffin and the olefin is in the range of about 1:1 to about 100:1, for example, or in the range of about 2:1 to about 50:1, or about 2:1 to about 40:1, or about 2:1 to about 30:1, or about 2:1 to about 20:1, or about 2:1 to about 15:1, or about 5:1 to about 50:1, or about 5:1 to about 40:1, or about 5:1 to about 30:1, or about 5:1 to about 20:1, or about 5:1 to about 15:1, or about 8:1 to about 50:1, or about 8:1 to about 40:1, or about 8:1 to about 30:1, or about 8:1 to about 20:1, or about 8:1 to about 15:1.

In a semi-batch system, the ionic liquid catalyst composition (including the trialkylphosphonium haloaluminate compound(s), optional co-catalyst, and any quaternary phosphonium haloaluminate compound(s)) and isoparaffin are introduced first, followed by the olefin or a mixture of isoparaffin and olefin. The catalyst is measured in the reactor with respect to the amount of olefins, with a catalyst to olefin weight ratio between about 0.1 and about 10, or between about 0.2 and about 5, or between about 0.5 and about 2. Vigorous stirring is desirable to ensure good contact between the reactants and the catalyst. The reaction temperature can be in the range of about 0° C. to about 100° C., or about 20° C. to about 70° C. The pressure can be in the range from atmospheric pressure to about 8000 kPa, preferably sufficient to keep the reactants in the liquid phase. Residence time of reactants in the vessel is in the range of a few seconds to hours, preferably about 0.5 min to about 60 min. The heat generated by the reaction can be eliminated using any of the means known to the skilled person. At the reactor outlet, the hydrocarbon phase is separated from the ionic liquid phase by gravity settling based on density differences, or by other separation techniques known to those skilled in the art. Then the hydrocarbons are separated by distillation and the starting isoparaffin which has not been converted is recycled to the reactor.

In a continuous system, the ionic liquid catalyst composition (including the trialkylphosphonium haloaluminate compound(s), optional co-catalyst, and any quaternary phosphonium haloaluminate compound(s)), the isoparaffin, and the olefin are each added continuously. The ionic liquid catalyst composition, unreacted isoparaffin, and unreacted olefin are each removed continuously from the reaction zone along with alkylate product. The ionic liquid catalyst composition, unreacted isoparaffin, and/or unreacted olefin may be recycled. The olefin may be added to one or more locations in the reaction zone. It is preferable to add the olefin to multiple locations in the reaction zone. Adding olefin in multiple locations, or spreading the olefin addition over a longer period of time results in a higher isoparaffin to olefin ratio measured in a specific location at a specific point in time. The isoparaffin to olefin ratio is defined as the cumulative amount of isoparaffin divided by the cumulative amount of olefin added across the entire reaction zone.

Typical alkylation conditions may include an ionic liquid catalyst composition volume in the reactor of from about 1 vol % to about 50 vol %, a temperature of from about 0° C. to about 100° C., a pressure of from about 300 kPa to about 2500 kPa, an isobutane to olefin molar ratio of from about 2:1 to about 20:1, and a residence time of about 5 min to about 1 hour. The paraffin used in the alkylation process preferably comprises an isoparaffin having from 4 to 10 carbon atoms, or 4 to 8 carbon atoms, or 4 to 5 carbon atoms. The olefin used in the alkylation process preferably has from 2 to 10 carbon atoms, or 3 to 8 carbon atoms, or 3 to 5 carbon atoms.

One application of the alkylation process is to upgrade low value C₄ hydrocarbons to higher value alkylates. To that extent, one specific embodiment is the alkylation of butanes with butylenes to generate C₈ compounds. Preferred products include trimethylpentanes (TMP), and while other C₈ isomers are produced, the prevalent competing isomers are dimethylhexanes (DMH). The quality of the product stream can be measured in the ratio of TMP to DMH, with a high ratio desired.

In another aspect, the invention comprises passing an isoparaffin and an olefin to an alkylation reactor, where the alkylation reactor includes an ionic liquid catalyst to react the olefin with the isoparaffin to generate an alkylate. The isoparaffin has from 4 to 10 carbon atoms, and the olefin has from 2 to 10 carbon atoms. The ionic liquid catalyst composition comprises the trialkylphosphonium haloaluminates described above.

The FIGURE illustrates one embodiment of an alkylation process 100 utilizing the trialkylphosphonium ionic liquid catalyst composition. An isoparaffin feed stream 105, an olefin feed stream 110, and a trialkylphosphonium ionic liquid catalyst composition stream 115 (including the trialkylphosphonium haloaluminate compound(s), optional co-catalyst, and any quaternary phosphonium haloaluminate compound(s)) are fed to an alkylation zone 120. The isoparaffin and the olefin react in the presence of the trialkylphosphonium ionic liquid catalyst composition to form alkylate.

The effluent 125 from the alkylation zone 120 contains alkylate, unreacted isoparaffins, the trialkylphosphonium ionic liquid catalyst composition, and possibly unreacted olefins. The effluent 125 is sent to a separation zone 130 where it is separated into a hydrocarbon stream 135 comprising the alkylate and unreacted isoparaffins (and any unreacted olefins) and an ionic liquid recycle stream 140 comprising the trialkylphosphonium ionic liquid catalyst composition. Suitable separation zones include, but are not limited to, gravity settlers, coalescers, filtration zones comprising sand or carbon, adsorption zones, scrubbing zones, or combinations thereof.

The hydrocarbon stream 135 is sent to a hydrocarbon separation zone 145 where it is separated into an alkylate stream 150 and an isoparaffin recycle stream 155. The alkylate stream 150 can be recovered and further treated as needed. The isoparaffin recycle stream 155 can be recycled to the alkylation zone 120, if desired. Suitable hydrocarbon separation zones include, but are not limited to, distillation or vaporization.

The ionic liquid recycle stream 140 can be recycled to the alkylation zone 120, if desired. In any or all embodiments, at least a portion 160 of the ionic liquid recycle stream 140 can be sent to a regeneration zone 165 to regenerate the trialkylphosphonium ionic liquid catalyst composition. The regenerated ionic liquid recycle stream 170 can be recycled to the alkylation zone.

Various methods for regenerating ionic liquids could be used. For example, U.S. Pat. No. 7,651,970; U.S. Pat. No. 7,825,055; U.S. Pat. No. 7,956,002; U.S. Pat. No. 7,732,363, each of which is incorporated herein by reference, describe contacting ionic liquid containing the conjunct polymer with a reducing metal (e.g., Al), an inert hydrocarbon (e.g., hexane), and hydrogen and heating to about 100° C. to transfer the conjunct polymer to the hydrocarbon phase, allowing for the conjunct polymer to be removed from the ionic liquid phase. Another method involves contacting ionic liquid containing conjunct polymer with a reducing metal (e.g., Al) in the presence of an inert hydrocarbon (e.g. hexane) and heating to about 100° C. to transfer the conjunct polymer to the hydrocarbon phase, allowing for the conjunct polymer to be removed from the ionic liquid phase. See e.g., U.S. Pat. No. 7,674,739 B2; which is incorporated herein by reference. Still another method of regenerating the ionic liquid involves contacting the ionic liquid containing the conjunct polymer with a reducing metal (e.g., Al), HCl, and an inert hydrocarbon (e.g. hexane), and heating to about 100° C. to transfer the conjunct polymer to the hydrocarbon phase. See e.g., U.S. Pat. No. 7,727,925, which is incorporated herein by reference. The ionic liquid can be regenerated by adding a homogeneous metal hydrogenation catalyst (e.g., (PPh₃)₃RhCl) to ionic liquid containing conjunct polymer and an inert hydrocarbon (e.g. hexane), and introducing hydrogen. The conjunct polymer is reduced and transferred to the hydrocarbon layer. See e.g., U.S. Pat. No. 7,678,727, which is incorporated herein by reference. Another method for regenerating the ionic liquid involves adding HCl, isobutane, and an inert hydrocarbon to the ionic liquid containing the conjunct polymer and heating to about 100° C. The conjunct polymer reacts to form an uncharged complex, which transfers to the hydrocarbon phase. See e.g., U.S. Pat. No. 7,674,740, which is incorporated herein by reference. The ionic liquid could also be regenerated by adding a supported metal hydrogenation catalyst (e.g. Pd/C) to the ionic liquid containing the conjunct polymer and an inert hydrocarbon (e.g. hexane). Hydrogen is introduced and the conjunct polymer is reduced and transferred to the hydrocarbon layer. See e.g., U.S. Pat. No. 7,691,771, which is incorporated herein by reference. Still another method involves adding a suitable substrate (e.g. pyridine) to the ionic liquid containing the conjunct polymer. After a period of time, an inert hydrocarbon is added to wash away the liberated conjunct polymer. The ionic liquid precursor [butylpyridinium] [Cl] is added to the ionic liquid (e.g. [butylpyridinium][Al₂Cl₇]) containing the conjunct polymer followed by an inert hydrocarbon. After mixing, the hydrocarbon layer is separated, resulting in a regenerated ionic liquid. See, e.g., U.S. Pat. No. 7,737,067, which is incorporated herein by reference. Another method involves adding ionic liquid containing conjunct polymer to a suitable substrate (e.g. pyridine) and an electrochemical cell containing two aluminum electrodes and an inert hydrocarbon. A voltage is applied, and the current measured to determine the extent of reduction. After a given time, the inert hydrocarbon is separated, resulting in a regenerated ionic liquid. See, e.g., U.S. Pat. No. 8,524,623, which is incorporated herein by reference. Ionic liquids can also be regenerated by contacting with silane compounds (U.S. Pat. No. 9,120,092), borane compounds (U.S. Publication No. 2015/0314281), Brønsted acids, (U.S. Pat. No. 9,079,176), or C₁ to C₁₀ paraffins (U.S. Pat. No. 9,079,175), each of which is incorporated herein by reference. Regeneration processes utilizing silane and borane compounds are described in U.S. application Ser. Nos. 14/269,943 and 14/269,978, each of which is incorporated herein by references.

### Various Embodiments

The invention as fully described herein includes at least the following embodiments:

### Embodiment 1

A trialkylphosphonium haloaluminate compound having a formula:

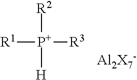

wherein R¹, R², and R³ are the same or different and each is independently selected from C₁ to C₈ hydrocarbyl; and

X is selected from F, Cl, Br, I, or combinations thereof;

with the proviso that when X is C1, R1, R², and R³ are not all methyl.

### Embodiment 2

The compound of embodiment 1 wherein R¹, R², and R³ are C₁ to C₆ hydrocarbyl.

### Embodiment 3

The compound of embodiment 1 or embodiment 2 wherein R¹, R², and R³ have the same number of carbon atoms.

### Embodiment 4

The compound of any one of embodiments 1 to 3 wherein R¹, R², and R³ are identical.

### Embodiment 5

The compound of any one of embodiments 1 to 4 wherein each of R¹, R², and R³ is selected from the group consisting of methyl, ethyl, propyl, butyl, pentyl, and hexyl.

### Embodiment 6

The compound of any one of embodiments 1 to 5 wherein the trialkylphosphonium haloaluminate compound is tri-n-butylphosphonium Al₂Cl₇⁻.

### Embodiment 7

The compound of any one of embodiments 1 to 5 wherein the trialkylphosphonium haloaluminate compound is tri-isobutylphosphonium Al₂Cl₇⁻.

### Embodiment 8

The compound of any one of embodiments 1 to 3 wherein the trialkylphosphonium haloaluminate compound is di-n-butyl-sec-butylphosphonium Al₂Cl₇⁻.

### Embodiment 9

An ionic liquid catalyst composition comprising one or more trialkylphosphonium haloaluminate compounds according to any one of embodiments 1 to 8.

### Embodiment 10

The ionic liquid catalyst composition of embodiment 9 wherein the trialkylphosphonium haloaluminate compound has the formula

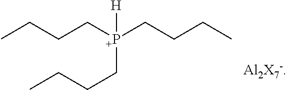

### Embodiment 11

The ionic liquid catalyst composition of embodiment 9 or embodiment 10 wherein an initial kinematic viscosity of the ionic liquid catalyst composition is less than about 70 cSt at 25° C.

### Embodiment 12

The ionic liquid catalyst composition of any one of embodiments 9 to 11 wherein an initial kinematic viscosity of the ionic liquid catalyst composition is less than about 45 cSt at 38° C.

### Embodiment 13

The ionic liquid catalyst composition of any one of embodiments 9 to 12 wherein an initial kinematic viscosity of the ionic liquid catalyst composition is less than about 33 cSt at 50° C.

### Embodiment 14

The ionic liquid catalyst composition of any one of embodiments 9 to 13, wherein a molar ratio of aluminum to phosphorous in the ionic liquid catalyst composition is in the range of 1.8 to 2.2.

### Embodiment 15

The ionic liquid catalyst composition of any one of embodiments 9 to 14, further comprising a quaternary phosphonium haloaluminate compound having a formula:

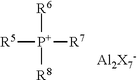

where R⁵-R⁷ are the same or different and each is independently selected from a C₁ to C₈ hydrocarbyl;

R⁸ is different from R⁵-R⁷ and is selected from a C₁ to C₁₅ hydrocarbyl; and

X is selected from F, Cl, Br, I, or combinations thereof.

### Embodiment 16

The ionic liquid catalyst composition of embodiment 15, wherein each of R⁵-R⁷ is independently chosen from a C₃-C₆ alkyl.

### Embodiment 17

The ionic liquid catalyst composition of embodiment 15 or embodiment 16, wherein R⁵-R⁷ are the same.

### Embodiment 18

The ionic liquid catalyst composition of any one of embodiments 15 to 17, wherein R⁸ is a C₄-C₁₂ hydrocarbyl.

### Embodiment 19

The ionic liquid catalyst composition of embodiment 18, wherein R⁸ is a C₄-C₈ alkyl.

### Embodiment 20

The ionic liquid catalyst composition of any one of embodiments 15 to 19, wherein a concentration of the trialkylphosphonium haloaluminate compounds is about 5 mol % to about 98 mol % of the total concentration of the ionic liquid catalyst composition.

### Embodiment 21

The ionic liquid catalyst composition of embodiment 20, wherein the trialkylphosphonium haloaluminate compound is present at a concentration from about 51 mol % to about 98 mol % of the total concentration of the ionic liquid catalyst composition.

### Embodiment 22

The ionic liquid catalyst composition of any one of embodiments 9 to 21 further comprising a co-catalyst.

### Embodiment 23

The ionic liquid catalyst composition of embodiment 22 wherein the co-catalyst comprises a Brønsted acid selected from the group consisting of HCl, HBr, HI, and mixtures thereof; or a Brønsted acid precursor selected from the group consisting of 2-chlorobutane, 2-chloro-2-methylpropane, 1-chloro-2-methylpropane, 1-chlorobutane, 2-chloropropane, 1-chloropropane, and mixtures thereof; and mixtures thereof.

### Embodiment 24

A process of making a trialkylphosphonium haloaluminate compound comprising:

reacting a trialkylphosphonium halide—having a general formula:

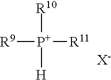

where R⁹, R¹⁰, and R¹¹ are the same or different and each is independently selected from C₁ to C₈ hydrocarbyl; and X is selected from F, Cl, Br, or I;

with at least one of AlCl₃, AlBr₃ or AlI₃ to form the trialkylphosphonium haloaluminate ionic liquid compound.

### Embodiment 25

The process of embodiment 24 wherein the trialkylphosphonium halide comprises trimethyl phosphonium halide, triethyl phosphonium halide, tripropyl phosphonium halide, tri n-butyl phosphonium halide, tri-isobutyl phosphonium halide, di-n-butyl-sec-butylphosphonium halide, tripentyl phosphonium halide, trihexylphosphonium halide, or combinations thereof.

### Embodiment 26

The process of embodiment 24 or embodiment 25 wherein the reaction conditions include a temperature in a range of about 20° C. to about 170° C., and about 1.8 to about 2.2 molar equivalents of AlCl₃, AlBr₃ or AlI₃.

### Embodiment 27

Use of a trialkylphosphonium haloaluminate compound as defined by any one of embodiments 1 to 8 as an ionic liquid catalyst for reacting olefins and isoparaffins to generate an alkylate.

### EXAMPLES

### Example 1

Synthesis of Tributylphosphonium heptachlorodialuminate (TBP-Al₂Cl₇)

The synthetic route for tributylphosphonium heptachlorodialuminate is depicted below and described in detail:

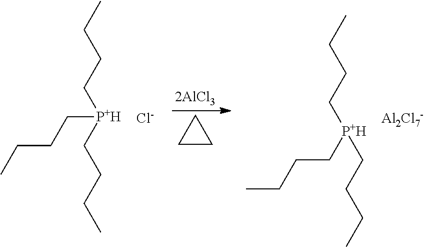

A) Tributylphosphonium chloride (70.3 g, 0.294 moles) is added to a 500 mL round bottom flask equipped with a stir bar, thermowell, a screw-type solids addition funnel and nitrogen supply valve under a nitrogen atmosphere. The flask is initially warmed to 50° C., then up to 120° C. (to maintain a molten mixture) while adding granular aluminum chloride (77.9 g, 0.584 moles (as AlCl₃)). After complete addition of the aluminum chloride, the reaction mixture is allowed to stir for an additional two hours, then cooled with agitation for another hour. The liquid product is isolated and stored under nitrogen. A total of 139 g of trialkylphosphonium heptachlorodialuminate is recovered analyzing as 97% tri(n-butyl)phosphonium heptachlorodialuminate and 3% di(n-butyl)(s-butyl)phosphonium heptachlorodialuminate (³¹P NMR area percent) (synthesized by Cytec Canada Inc., of Welland, Ontario). (³¹P NMR area percent). ³¹P {¹H} NMR (243 MHz, CD₃CN): δ20.55 (singlet, PH(CH₂CH₂CH₂CH₃)₂(CH(CH₃)CH₂CH₃), minor), δ12.70 (singlet, PH(CH₂CH₂CH₂CH₃)₃, major). ¹H NMR (600 MHz, CD₃CN): δ5.92 (dp, ¹J_{HP}=476 Hz, ³J_{HH}=5.4 Hz, 0.34H, P_{H}(CH₂CH₂CH₂CH₃)₃), δ2.196 (m, 2.02H, PH(CH₂CH₂CH₂CH₃)₃), δ1.605 (m, 2.03H, P_{H}(CH₂CH₂CH₂CH₃)₃), δ1.477 (sextet, ³J_{HH}=7.2 Hz, 2.04H, PH(CH₂CH₂CH₂CH₃)₃), δ0.963 (t, ³J_{HH}=7.8 Hz, 3.00H, PH(CH₂CH₂CH₂CH₃). ¹³C {¹H} NMR (151 MHz, CD₃CN): δ24.215 (d, J_{CP}=4.53 Hz), δ23.31 (d, J_{CP}=15.1 Hz), δ16.10 (d, J_{CP}=45 Hz), δ12.76 (s).
B) Reagents are weighed in the glove box. 132.26 g (0.5539 mol) of Bu₃PHCl is placed into a 500 mL flask and 147.74 g (1.1080 mol) of AlCl₃ is added via a solid addition funnel. Under N₂ purging, the glassware is assembled in the fume hood along with a water-cooled condenser and magnetic stir bar. The Bu₃PHCl is heated to about 60° C., and the heat turned off to start the addition, which is exothermic. The AlCl₃ is added at a rate to maintain an internal temperature of about 100° C. The mixture of the two reagents at about half way through the addition solidifies at about 94° C. The addition is stopped, and heat is applied to 100° C. The addition is started again. The reaction pot is solidifying even at 107° C. The addition is stopped and continued the following day. On cooling, the pot contents fully solidified, and the heat is set to 100° C. The lower half of the flask becomes molten while the upper stays solid. A heat gun is used to gently heat the edges and melt the upper portion. The thermowell tip still has material solidified around it, and when it releases the temperature increases rapidly to 124-125° C. The heat is turned off, and the pot is left to cool closer to 100° C. Around 108° C., the pot contents start going solid again, the heat is then set to 120° C. When the pot contents are homogeneous and stirring efficiently, the addition of AlCl₃ is continued. Gas formation ceases shortly within the exothermic activity subsiding on addition. Once all solids are added, the pot is left to stir set at 100° C. for 30 minutes. As there are still solids floating in the mix and some crusting around the flask necks, the flask was shaken to try to rinse the residue into the pot. The flask is stirred for an additional 40 minutes at 100° C. then removed. The material is transferred to jars in the glove box. A 30 mL jar is removed from the glove box and opened under N₂ to sample for NMR. A total of 271.4 g of trialkylphosphonium heptachlorodialuminate is recovered analyzing as 97% tri(n-butyl)phosphonium heptachlorodialuminate and 3% di(n-butyl)(s-butyl)phosphonium heptachlorodialuminate (³¹P NMR area percent) (synthesized by Cytec Canada Inc., of Welland, Ontario).

### ALKYLATION EXPERIMENTS

### Comparative Example 1

7.999 g (0.0139 mol) of tributylpentylphosphonium (TBPP) heptachlorodialuminate ionic liquid, prepared by a method analogous to the method described in Example 1 of US Publication No. 2013/0345484, was loaded in a 300 cc autoclave with 0.422 g (0.0046 mol) of 2-chlorobutane (used as a co-catalyst). The autoclave was fitted with a Cowles-type impeller. 80 g of isobutane was charged, and the reactor was pressurized to about 3.4 MPa(g) (500 psig) with nitrogen. After pressurizing the reactor, the mixture was stirred at 1700-1900 rpm for 20 minutes to ensure breakdown of the 2-chlorobutane. The reaction was initiated by the addition of approximately 8 g of 2-butenes (mixed cis- and trans-isomers) over the course of 2.5 minutes while mixing at 1900 rpm. The 2-butenes blend also contained about 8.5 wt % n-pentane that was used as a tracer to verify the amount of butenes added (butenes added=wt n-pentane added*wt % butenes in feed/wt % n-pentane in feed). Mixing was stopped, and the mixture was allowed to settle. The hydrocarbon was analyzed by gas chromatography (GC). Table 2 shows the results. The n-pentane tracer indicated that 7.95 g of 2-butenes were added. The butenes conversion was 99.94%. The hydrocarbon contained 19.5 wt % C₅₊ (products having 5 carbon atoms or more). Of the C₅₊ products, 72.3% was octanes, 6.8% was isopentane, 5.8% was hexanes, 5.1% was heptanes, and 10.1% was C₉₊ (products containing 9 carbon atoms or more). Among the octanes, the ratio of trimethylpentanes to dimethylhexanes (TMP/DMH) was 12.6. The calculated research octane number (RONC) was 95.1. The results are shown in Table 2.

The selectivity to a particular product or group of products is defined as the amount of the particular product or group of products in weight percent, divided by the amount of products containing a number of carbon atoms greater than the number of carbon atoms in one isoparaffin reactant in weight percent. For example for the alkylation of isobutane and butene, the selectivity for C₈ hydrocarbons is the wt % of hydrocarbons containing exactly 8 carbon atoms in the product divided by the wt % of all products containing 5 or more carbon atoms. Similarly, the selectivity to C₅-C₇ hydrocarbons is the wt % of hydrocarbons containing exactly 5, 6 or 7 carbon atoms in the product divided by the wt % of all products containing 5 or more carbon atoms, and the selectivity to C₉+ hydrocarbons is the wt % of hydrocarbons containing 9 or more carbon atoms in the product divided by the wt % of all products containing 5 or more carbon atoms.

Research octane number, calculated (RONC) is determined by summing the volume normalized blending octanes of all products the containing 5 carbons or more according to:

$$RONC = \frac{1}{V} {\sum }_{i}^{ } {BN}_{i} \frac{{m}_{i}}{{ρ}_{i}}$$

where BN are blending octane numbers shown in Table 1, mᵢ is the mass of product i in the stream, ρᵢ is the pure component density of product i, and V is the total volume of all products (not including un-reacted feeds, or ionic liquid).

TABLE 1
Density and Octane Blending Numbers for Alkylation Products

| Compound Name | Density g/cc | BN |
|---|---|---|
| Ethane | 0.409661 | 0 |
| Propane | 0.507652 | 0 |
| n-butane | 0.584344 | 95 |
| isopentane | 0.6247 | 93.5 |
| 2,2-dimethylbutane | 0.653938 | 94 |
| 2,3-dimethylbutane | 0.6664 | 103 |
| 2-methylpentane | 0.6579 | 74 |
| 3-methylpentane | 0.6689 | 75.5 |
| n-hexane | 0.6640 | 31.0 |
| 2,2,3-trimethylbutane | 0.6901 | 112.1 |
| 2,2-dimethylpentane | 0.6782 | 92.8 |
| 2,3-dimethylpentane | 0.6996 | 91 |
| 2,4-dimethylpentane | 0.6773 | 83 |
| 3,3-dimethylpentane | 0.6976 | 80.8 |
| 2-methylhexane | 0.683 | 42.4 |
| 3-methylhexane | 0.6917 | 52 |
| 2,2,3-trimethylpentane | 0.7202 | 109 |
| 2,2,4-trimethylpentane | 0.6962 | 100 |
| 2,3,3-trimethylpentane | 0.7303 | 106 |
| 2,3,4-trimethylpentane | 0.7233 | 102.5 |
| 2,2-dimethylhexane | 0.6997 | 72.5 |
| 2,3-dimethylhexane | 0.7165 | 56 |
| 2,4-dimethylhexane | 0.7013 | 60 |
| 2,5-dimethylhexane | 0.6979 | 55 |
| 3,3-dimethylhexane | 0.7143 | 75.5 |
| 2-methylheptane | 0.7021 | 25 |
| 3-methylheptane | 0.7101 | 25 |
| 4-methylheptane | 0.7000 | 24.0 |
| Lumped C9+ | 0.74 | 78.5 |

### Example 2

7.005 g (0.0139 mol) of tributylphosphonium (TBP) heptachlorodialuminate ionic liquid from example 1A was loaded in a 300 cc autoclave with 0.335 g (0.0036 mol) of 2-chlorobutane. The autoclave was fitted with a Cowles-type impeller. 80 g of isobutane was charged, and the reactor was pressurized to about 3.4 MPa(g) (500 psig) with nitrogen. After pressurizing the reactor, the mixture was stirred at 1700-1900 rpm for 20 minutes to ensure breakdown of the 2-chlorobutane. The reaction was initiated by the addition of approximately 8 g of 2-butenes (mixed cis- and trans-isomers) over the course of 2.5 minutes while mixing at 1900 rpm. The 2-butenes blend also contained about 8.5 wt % n-pentane that was used as a tracer to verify the amount of butenes added. The mixing was stopped, and the mixture was allowed to settle. The hydrocarbon was analyzed by gas chromatography (GC). Table 2 shows the results. The n-pentane tracer indicated that 7.98 g of 2-butenes were added. The butenes conversion was 99.95%. The hydrocarbon contained 19.6 wt % C₅₊. Of the C₅₊ products, 72.4% was octanes, 8.6% was isopentane, 5.7% was hexanes, 4.6% was heptanes and 8.7% was C₉₊. Among the octanes, the ratio of trimethylpentanes to dimethylhexanes was 9.2. The calculated research octane number was 94.2. The results are shown in Table 2.

### Example 3

7.002 g (0.0139 mol) of tributylphosphonium heptachlorodialuminate ionic liquid from example 1A was loaded in a 300 cc autoclave with 0.304 g (0.0033 mol) of 2-chlorobutane. Here, less 2-chlorobutane was used compared to example 2. The autoclave was fitted with a Cowles-type impeller. 80 g of isobutane was charged and the reactor was pressurized to about 3.4 MPa(g) (500 psig) with nitrogen. After pressurizing the reactor, the mixture was stirred at 1700-1900 rpm for 20 minutes to ensure breakdown of the 2-chlorobutane. The reaction was initiated by the addition of approximately 8 g of 2-butenes (mixed cis- and trans-isomers) over the course of 2.5 minutes while mixing at 1900 rpm. The 2-butenes blend also contained about 8.5 wt % n-pentane that was used as a tracer to verify the amount of butenes added. The mixing was stopped, and the mixture was allowed to settle. The hydrocarbon was analyzed by gas chromatography (GC). Table 2 shows the results. The n-pentane tracer indicated that 7.30 g of 2-butenes were added. The butenes conversion was 99.94%. The hydrocarbon contained 18.4 wt % C₅₊. Of the C₅₊ products, 76% was octanes, 6.7% was isopentane, 4.9% was hexanes, 4.5% was heptanes and 7.9% was C₉₊. Among the octanes, the ratio of trimethylpentanes to dimethylhexanes was 11.0. The calculated research octane number was 95.2. The results are shown in Table 2.

### Example 4

7.204 g (0.0125 mol) of tributylpentylphosphonium heptachlorodialuminate ionic liquid and 0.814 g (0.0016 mol) tributylphosphonium heptachlorodialuminate ionic liquid from example 1A were both loaded in a 300 cc autoclave with 0.425 g (0.0046 mol) of 2-chlorobutane. The autoclave was fitted with a Cowles-type impeller. 80 g of isobutane was charged and the reactor was pressurized to about 3.4 MPa(g) (500 psig) with nitrogen. After pressurizing the reactor, the mixture was stirred at 1700-1900 rpm for 20 minutes to ensure breakdown of the 2-chlorobutane. The reaction was initiated by the addition of approximately 8 g of 2-butenes (mixed cis- and trans-isomers), over the course of 2.5 minutes while mixing at 1900 rpm. The 2-butenes blend also contained about 8.5 wt % n-pentane that was used as a tracer to verify the amount of butenes added. The mixing was stopped, and the mixture was allowed to settle. The hydrocarbon was analyzed by gas chromatography (GC). Table 2 shows the results. The n-pentane tracer indicated that 8.12 g of 2-butenes were added. The butenes conversion was 99.96%. The hydrocarbon contained 19.8 wt % C₅₊. Of the C₅₊ products, 74.0% was octanes, 6.6% was isopentane, 5.6% was hexanes, 4.7% was heptanes and 9.0% was C₉₊ (products containing 9 carbon atoms or more). Among the octanes, the ratio of trimethylpentanes to dimethylhexanes was 13.3. The calculated research octane number was 95.5. The results are shown in Table 2.

TABLE 2
Alkylation Reactions with Tributylphosphonium-Al₂Cl₇
and Comparison to Tributylpentylphosphonium-Al₂Cl₇

| | Comp 1 | Ex 2 | Ex 3 | Ex 4 |
|---|---|---|---|---|
| IL cation | TBPP | TBP | TBP | 88.7 mol % |
| | | | | TBPP, 11.3 |
| | | | | mol % TBP |
| 2-chlorobutane | 0.422 | 0.335 | 0.304 | 0.425 |
| added (g) | | | | |
| Butenes | 99.94% | 99.95% | 99.94% | 99.96% |
| conversion | | | | |
| wt % C₅₊ | 19.5% | 19.6% | 18.4% | 19.8% |
| C₅ wt % sel. | 6.8% | 5.7% | 6.7% | 6.6% |
| C₆ wt % sel. | 5.8% | 4.6% | 4.9% | 5.6% |
| C₇ wt % sel. | 5.1% | 8.7% | 4.5% | 4.7% |
| C₈ wt % sel. | 72.3% | 72.4% | 76.0% | 74.0% |
| C₉₊ wt % sel. | 10.1% | 8.7% | 7.9% | 9.0% |
| TMP/DMH | 12.6 | 9.2 | 11.0 | 13.3 |
| RONC | 95.1 | 94.2 | 95.2 | 95.5 |

### Example 5

The kinematic viscosity of TBP-Al₂Cl₇ ionic liquid prepared in example 1A was measured. It had kinematic viscosity of 31.50 cSt at 25° C., 19.86 cSt at 38° C. and 13.91 cSt at 50° C. That is more viscous than 1-butyl-3-methyl imidazolium-Al₂Cl₇ (BMIM-Al₂Cl₇) (about 13 to 15 cSt at 25° C.), but lower than tribtuylmethylphosphonium-Al₂Cl₇ (TBMP-Al₂Cl₇) (about 55 to 57 cSt at 25° C.) or tributylpentylphosphonium-Al₂Cl₇ (TBPP-Al₂Cl₇) (about 80-95 cSt at 25° C.). Table 3 gives the kinematic viscosity for TBP-Al₂Cl₇, TBPP-Al₂Cl₇, and a blend of 10 wt % TBP-Al₂Cl₇ and 90 wt % TBPP-Al₂Cl₇.

The relative density of the ionic liquid was also measured at 25° C. using ASTM method D4052. The relative density was 1.2203 g/cm³.

TABLE 3
Kinematic viscosity

| | | Kinematic | Kinematic | Kinematic |
|---|---|---|---|---|
| | | viscosity at | viscosity at | viscosity at |
| IL | Al/P mol | 25° C. (cSt) | 38° C. (cSt) | 50° C. (cSt) |
| TBP | 2.07 | 31.50 | 19.86 | 13.91 |
| TBPP | 2.16 | 83.81 | 48.39 | 31.51 |
| TBPP | 1.95 | 90.49 | 52.12 | 34.20 |
| 10 wt % | 10 wt % | 78.19 | 45.91 | 30.18 |
| TBP, | Bu₃PH (2.07 | | | |
| 90 wt % | Al/P), 90 wt % | | | |
| TBPP | TBPP (1.95 Al/P) | | | |

### Example 6

The melting point of TBP-Al₂Cl₇ prepared in example 1A was measured. Melting occurred between 15-17° C.

### Example 7

The spent ionic liquid from example 2 was analyzed by NMR (in CDCl₃) to determine if alkylation of the phosphonium occurred. The main resonance known to be tri(n-butyl)phosphonium heptachlorodialuminate was observed in the ³¹P NMR at 13.5 ppm. A second resonance corresponding to 4 mol % occurred at 21.8 ppm, corresponding to di(n-butyl)(s-butyl)phosphonium. However, it is not the expected alkylation product of tributylphosphonium and butene (tetrabutylphosphonium), which would have had a peak at 34 ppm (tetra n-butylphosphonium). The alkylate was also analyzed by ³¹P NMR to check for extraction of the phosphonium into the hydrocarbon phase. No resonances were observed. Elemental analysis by inductively charged plasma atomic emission spectroscopy of the alkylate product shows that no detectable phosphorous was found.

By the term “about,” we mean within 10% of the value, or within 5%, or within 1%.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed:

1. A trialkylphosphonium haloaluminate compound having a formula: 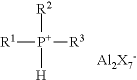
wherein R¹, R², and R³ are the same or different and each is independently selected from C₁ to C₈ hydrocarbyl; and
X is selected from F, Cl, Br, I, or combinations thereof;
with the proviso that when X is Cl, R1, R², and R³ are not all methyl.

2. The compound of claim 1 wherein R¹, R², and R³ are C₁ to C₆ hydrocarbyl.

3. The compound of claim 1 wherein R¹, R², and R³ have the same number of carbon atoms.

4. The compound of claim 1 wherein R¹, R², and R³ are identical.

5. The compound of claim 1 wherein each of R¹, R², and R³ is independently selected from the group consisting of methyl, ethyl, propyl, butyl, pentyl, and hexyl.

6. The compound of claim 1 wherein the trialkylphosphonium haloaluminate compound is tri-n-butylphosphonium Al₂Cl₇⁻.

7. The compound of claim 1 wherein the trialkylphosphonium haloaluminate compound is tri-isobutylphosphonium Al₂Cl₇⁻.

8. The compound of claim 1 wherein the trialkylphosphonium haloaluminate compound is di-n-butyl-sec-butylphosphonium Al₂Cl₇⁻.

9. An ionic liquid catalyst composition comprising one or more trialkylphosphonium haloaluminate compounds as defined by claim 1.

10. The ionic liquid catalyst composition of claim 9 wherein the trialkylphosphonium haloaluminate compound has the formula

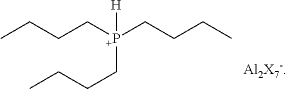

11. The ionic liquid catalyst composition of claim 9 wherein an initial kinematic viscosity of the ionic liquid catalyst composition is less than about 70 cSt at 25° C.

12. The ionic liquid catalyst composition of claim 9 wherein an initial kinematic viscosity of the ionic liquid catalyst composition is less than about 45 cSt at 38° C.

13. The ionic liquid catalyst composition of claim 9 wherein an initial kinematic viscosity of the ionic liquid catalyst composition is less than about 33 cSt at 50° C.

14. The ionic liquid catalyst composition of claim 9 wherein a molar ratio of aluminum to phosphorous in the ionic liquid catalyst composition is in the range of 1.8 to 2.2.

15. The ionic liquid catalyst composition of claim 9, further comprising a quaternary phosphonium haloaluminate compound having a formula: 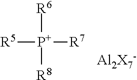
where R⁵-R⁷ are the same or different and each is independently selected from a C₁ to C₈ hydrocarbyl;
R⁸ is different from R⁵-R⁷ and is selected from a C₁ to C₁₅ hydrocarbyl; and
X is selected from F, Cl, Br, I, or combinations thereof.

16. The ionic liquid catalyst composition of claim 15, wherein each of R⁵-R⁷ is independently chosen from a C₃-C₆ alkyl.

17. The ionic liquid catalyst composition of claim 15, wherein R⁵-R⁷ are the same.

18. The ionic liquid catalyst composition of claim 15, wherein R⁸ is a C₄-C₁₂ hydrocarbyl.

19. The ionic liquid catalyst composition of claim 18, wherein R⁸ is a C₄-C₈ alkyl.

20. The ionic liquid catalyst composition of claim 15, wherein a concentration of the trialkylphosphonium haloaluminate compounds is about 5 mol % to about 98 mol % of the total concentration of the ionic liquid catalyst composition.

21. The ionic liquid catalyst composition of claim 20, wherein the trialkylphosphonium haloaluminate compound is present at a concentration from about 51 mol % to about 98 mol % of the total concentration of the ionic liquid catalyst composition.

22. The ionic liquid catalyst composition of claim 9 further comprising a co-catalyst.

23. The ionic liquid catalyst composition of claim 22 wherein the co-catalyst comprises a Brønsted acid selected from the group consisting of HCl, HBr, HI, and mixtures thereof; or a Brønsted acid precursor selected from the group consisting of 2-chlorobutane, 2-chloro-2-methylpropane, 1-chloro-2-methylpropane, 1-chlorobutane, 2-chloropropane, 1-chloropropane, and mixtures thereof; and mixtures thereof.

24. A process of making a trialkylphosphonium haloaluminate compound comprising:
reacting a trialkylphosphonium halide—having a general formula: 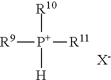
where R⁹, R¹⁰, and R¹¹ are the same or different and each is independently selected from C₁ to C₈ hydrocarbyl; and X is selected from F, Cl, Br, or I;
with at least one of AlCl₃, AlBr₃ or AlI₃ to form the trialkylphosphonium haloaluminate ionic liquid compound.

25. The process of claim 24 wherein the trialkylphosphonium halide comprises trimethyl phosphonium halide, triethyl phosphonium halide, tripropyl phosphonium halide, tri n-butyl phosphonium halide, tri-isobutyl phosphonium halide, di-n-butyl-sec-butylphosphonium halide, tripentyl phosphonium halide, trihexylphosphonium halide, or combinations thereof.

26. The process of claim 24 wherein the reaction conditions include a temperature in a range of about 20° C. to about 170° C., and about 1.8 to about 2.2 molar equivalents of AlCl₃, AlBr₃ or AlI₃.
